(19) United States
(12) Patent Application Publication
(10) Pub. No.: US 2005/0216832 A1
(43) Pub. Date: Sep. 29, 2005

(54) Generation of documents

(75) Inventor: Fabio Giannetti, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/836,337

(22) Filed: May 3, 2004

(30) Foreign Application Priority Data
Oct. 31, 2003 (GB) 0325478.6

(51) Int. Cl. G06F 17/00

(52) U.S. Cl. 715/513; 715/521

(57) ABSTRACT

A method of generating a document comprises: receiving a document template and a set of base content items for inclusion in said document; rendering an initial set of said base content items; determining an extent of any void spaces in said document after rendering of said base content items; and depending upon an extent of said void spaces, inserting a further additional content item into said document.

### FIELD OF THE INVENTION

The present invention relates to the generation of documents, for example by the rendering of documents in a digital printing system.

### BACKGROUND TO THE INVENTION

Known publishing solutions operate either by using a known off set printing press, or by using a digital printing press. With a conventional off set printing press, a master document needs to be copied and then the run of copies are printed off. Known digital printing presses have an advantage that successive individual print items which are different to each other can be printed without interrupting the work flow, i.e. the logical sequence of steps required to perform a printing operation. With the known digital printing press, a digital master document is provided electronically, and the number of print items in a print run is variable. Small print runs from one print item output can be accommodated.

Known digital printing presses are capable of printing a print run comprising a plurality of print items, wherein individual print items within the print run are different to each other.

Referring to FIG. 1 herein, there is illustrated schematically in perspective view a known digital printing press.

The introduction of digital printing presses enables creation of more personalised documents, with an increasingly large amount of variable data. This changes the way in which high quality full colour documents are designed, and has lead printing press producers to introduce a new standard to help graphic artists, marketing managers, and databases administrators to integrate their job in order to obtain the highly customised, variable documents capable of being produced by modern printing presses.

Two known formats currently dominate, these being PPML (Personalised Printing Mark-up Language), and PPML/T (PPML templating). The adoption of these two formats helps the generation of variable data print (VDP) work flows, where design templates and data can be shared between the different persons involved in printing.

This technology also enables high re-use of assets and the possibility for the Print Shop (print service provider—PSP) to consume partially fulfilled documents and replace the variable elements very close to the actual rasterizing process.

The PPML document comprises one or a plurality of pages. Each page has one or more “copy holes” which can be positioned by a user on the page. Each copy hole is defined by a width a, height, and a 2-dimensional position on a page.

Inside each copy hole there is placed content, for example text content comprising a plurality of lines of text. Consequently, in known PPML work flows, everything is static. All aspects of layout and content are pre-determined and are positioned on the page, including the copy holes, and the content within the copy holes. A graphic artist designs the PPML page, and then inserts static text and/or objects within the copy holes using a conventional graphic artist package, for example the known ‘Express’ tool from QUARK.

In contrast, the known language extensible style sheet formatting objects XSL-FO belongs to a class of languages known as document description languages, DDL, which are languages which describe whole documents, rather than individual pages. In XSL-FO, there is no concept of one page, but there is a concept of a sequence of pages making up a document, and there is also a concept of where the content will be positioned within a page sequence.

Known rendering engines are not capable of completing additional blank spaces in documents.

### SUMMARY OF THE INVENTION

According to a first aspect of the present invention, there is provided a method of generating a document comprising:

receiving a document template and a set of base content items for inclusion in said document;

rendering an initial set of said base content items;

determining an extent of any void spaces in said document after rendering of said base content items; and

depending upon an extent of said void spaces, inserting a further is additional content item into said document.

According to a second aspect of the present invention, there is provided an apparatus for generating a rendered document, comprising:

a rendering engine operable for rendering said document;

a component operable for identifying void spaces in said document;

a component capable of supplying at least one additional content item and capable of incorporating said at least one additional content item into said document; wherein

said rendering engine is operable for rendering said document, inclusive of said at least one additional content item.

According to a third aspect of the present invention, there is provided a method of generating a print run, said method comprising:

generating a base document in a document description language as a result of applying a set of pre-rendering rules and a set of variable data to a document model;

identifying at least one void area in said base document;

generating information describing a location of said at least one void area;

applying a set of rules which assign content to said at least one void area;

obtaining at least one additional content item in response to a said identified at least one void area; and

generating a rendered document incorporating said at least one additional content item into said base document.

According to a fourth aspect of the present invention, there is provided a digital press comprising:

a rendering engine capable of identifying at least one void space within a document received by said rendering engine;

means for generating information describing a location of said void space;

means for applying a set of rules which assign additional content to said void area; and

means for rendering said base document, incorporating said additional content items, to produce an output rendered document.

According to a fifth aspect of the present invention, there is provided a rendering engine comprising:

means for identifying content items in a copy flow, and converting said copy items to objects;

storage means for storing said plurality of objects;

means for arranging said objects into an object structure in which a location of each object in said storage means is recorded;

means for determining a page layout of said plurality of objects in a plurality of pages of said copy flow; and

an interface means for allowing an external application to view said page layout, and to modify said page layout.

According to a sixth aspect of the present invention, there is provided a digital printing system comprising:

a pre-rendering rule engine capable of applying a set of pre-rendering rules to a document template, said pre-rendering rules operable for incorporating a set of base content data into said document template to produce a document in a document description language;

a rendering engine for rendering said document;

a post rendering rule engine operable for applying a set of additional content items to said document template, according to a set post rendering rules; and

a rendering engine for rendering at least one document according to said document template, inclusive of said base content items and said additional content items added as a result of said post rendering rules, to produce a rendered document.

Other aspects of the invention are as recited herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically in perspective view, a prior art digital printing press;

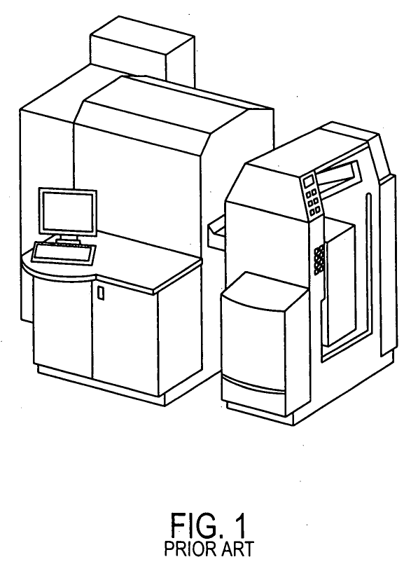

FIG. 2 illustrates schematically a digital printing system according to a first specific embodiment of the present invention, comprising a first computer entity hosting a graphic artist authoring tool; a second computer entity hosting a marketing manager tool; and a digital printing press adapted for applying a set of post rendering rules as described herein after;

FIG. 3 illustrates schematically first and second pages of a document specified in extensible style sheet language for formatting objects (XSL-FO);

FIG. 4 illustrates schematically an XSL-FO copy flow in which a document has a first page of content and a second page of content, wherein the second page of content is repeated many times;

FIGS. 5a to 5c illustrates schematically a content flow comprising a plurality of pages, containing variable content in which a first page A is filled with content, and a second page B₁, B₂, B₃, respectively is repeated, each time having varying amounts of content, and which may include void spaces;

FIG. 6 illustrates schematically in overview, processes carried out by a modified rendering engine for enabling an external component to view inside the rendering engine, and to affect internal operation of the rendering engine to modify documents by incorporation of additional content during a rendering operation according to the first specific embodiment of the present invention;

FIG. 7 illustrates schematically in further detail, processes carried out by a modified rendering engine for identification and organization of content items in a content flow, and a layout of those content items into pages;

FIG. 8 illustrates schematically a first digital printing system, in which a post rendering rule engine is incorporated into a digital printing press, and a pre-rendering rule engine is included externally of the digital printing press, in an external computer entity according to the first specific embodiment of the present invention;

FIG. 9 illustrates schematically a second digital printing system comprising a digital printing press, and a pre-rendering rule engine and a post rendering rule engine which are provided by computer entities external of the digital printing press, according to a second specific embodiment of the present invention;

FIG. 10 illustrates schematically a document file after a first rendering in which a set of base content items have been rendered, and the same document after a second rendering, in which an additional content item has been rendered, according to a specific method of the present invention;

FIG. 11 illustrates schematically first and second pages of a partially rendered document file in which a base content has been rendered, leaving a relatively large void space on a final page of the document; and

FIG. 12 illustrates schematically the second page of the document of FIG. 11, and a process applied by a digital printing system for incorporating an additional content item in the void space of the final page of the document according to another specific method of the present invention.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

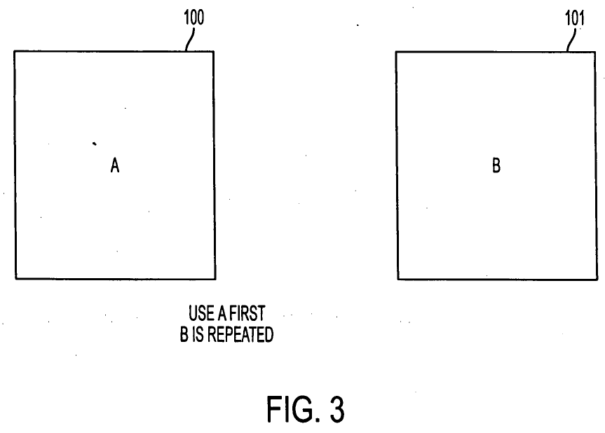

Referring to FIG. 3 herein, there is shown first and second pages 100, 101 respectively of a document within extensible style sheet language for formatting objects (XSL-FO).

Suppose that the first page 100 is to be used first, and the second page 101 is to be repeated several times.

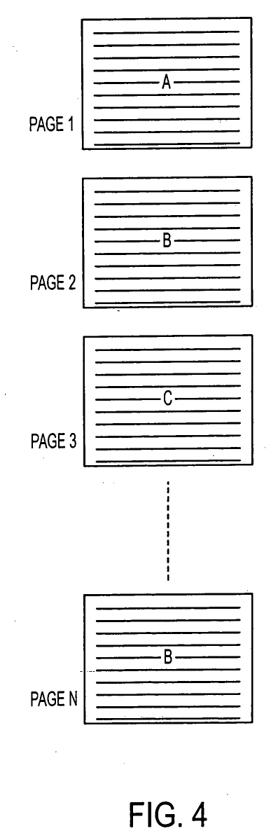

Referring to FIG. 4 herein, the resultant document comprises an XSL-FO document having first page 100, and second page 101 repeated any number of times.

A flow of copy comprises a plurality of documents, each of one or more pages, in a sequence. The copy flow may be specified by a document template, which applies to all documents in the flow, the document template specifying one or more static copy holes for including static content items which repeat from document to document within the flow, and one or more variable copy holes, which contain variable content which varies from document to document within the copy flow.

According to an embodiment of the present invention, a run of documents can be printed, wherein each document within a print run has a base content which may include both common types of content; static content which is common to, and re-occurs in different documents in the print run; and variable content which differs from document to document. Any void spaces in a document may be completed by inserting pre-determined items of additional content; being either static content, variable content, or a combination of both. The additional static and/or variable content for a particular document is determined by a set of rules which are applied after rendering the document, and which match the additional (static and/or variable) content to the existing base content of the document.

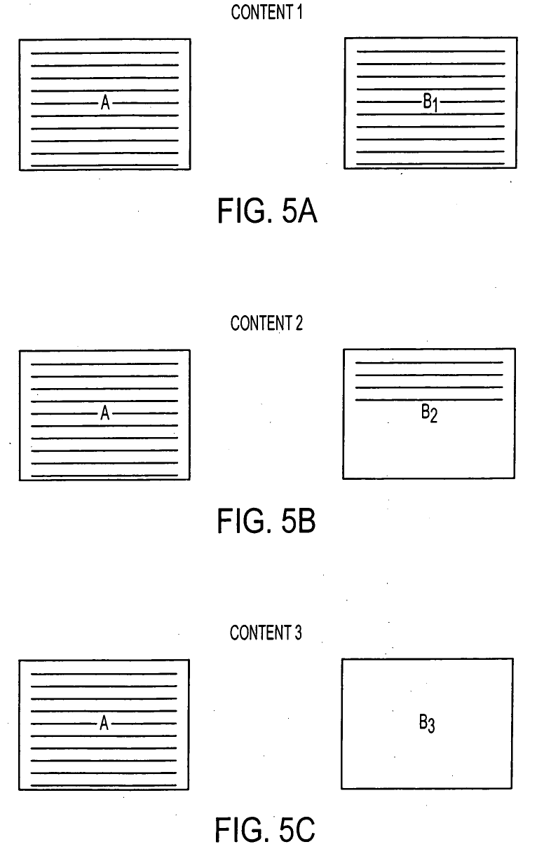

Referring to FIGS. 5a to 5c herein, there is illustrated schematically examples of output scalable vector graphic (SVG) documents from the rendering engine (rendering being a process in which content objects, such as lines of text, images, etc., are located on a page to create a layout). Such documents may include for example transactional documents such as credit cards statements or bank account statements, but in general any type of document may be rendered.

Referring to FIG. 5a herein, a first rendered SVG document has first and second pages A, B, respectively. The variable content on second page B, in this example fills the whole of a document page.

Referring to FIG. 5b herein, a second rendered SVG document comprises a fixed content page A₂, and variable content page B₂. In this example the variable content on the second page B₂ of the document fills half a page.

Referring to FIG. 5c herein, there is illustrated a third document output of the rendering engine comprising a first page of rendered content A₃, and a second page of variable content B₃. In this example, the variable content B₃ is empty, leaving a blank page.

For an XSL-FO document consisting of a fixed content page A, and one or more variable content pages B1, B2 . . . Bₙ, under some circumstances the rendered variable content can result in blank document pages, or document pages having only a small amount of content, leaving void spaces in the page.

Transactional documents have unpredictable lengths, and can span across an undetermined number of pages. However, it is important to be able to use any available space.

Usually, documents are published using an even number of pages, so the amount of space available which potentially arises on each document may be more than one page. By utilising this space, the document can be completed by addition of extra content, such as advertisements or other business information.

When dealing with high quality documents, such as those produced by digital printing press, many customers wish to avoid having empty space in a document, since this affects the presentation of a document, and represents a wasted opportunity for fully utilizing the document. Operators of digital printing presses often charge a cost per page, so the customer instructing the print run will pay for empty pages as well as pages which have a full amount of content. Further, customers also wish to have pages which are in full duplex, for example so that the pages can form a leaflet having printing on both sides of the pages.

Therefore, the rendering engine is modified to provide information on:

1. which page of a document a content terminates; and

2. a position on the page at which the content terminates.

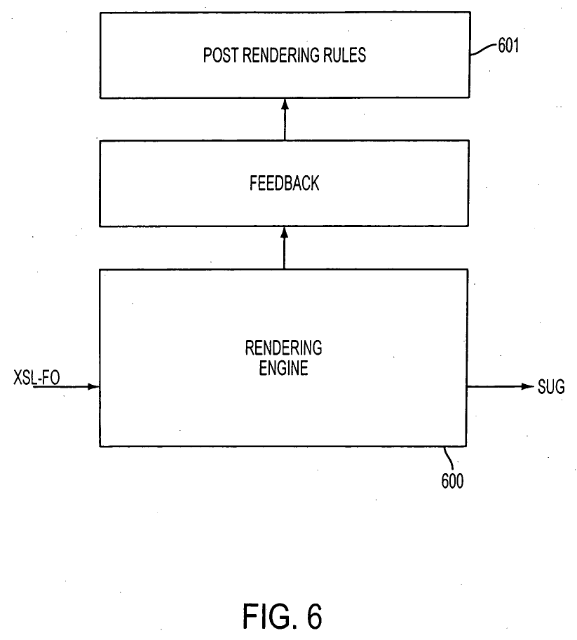

Referring to FIG. 6 herein, there is illustrated schematically a rendering engine which is capable of providing feedback on where a content terminates within an individual document in a print run, and which provides that information to a set of post rendering rules 601. The rendering engine 600 of a digital printing press is adapted for producing a rendered document according to an embodiment of method of the present invention. The rendering engine receives the XSL-FO document and renders it to produce a page description language (PDL) document, for example an SVG document. Methods and embodiments disclosed herein are based on XSL-FO technology, which is a W3C standard, which is well suited for transactional documents.

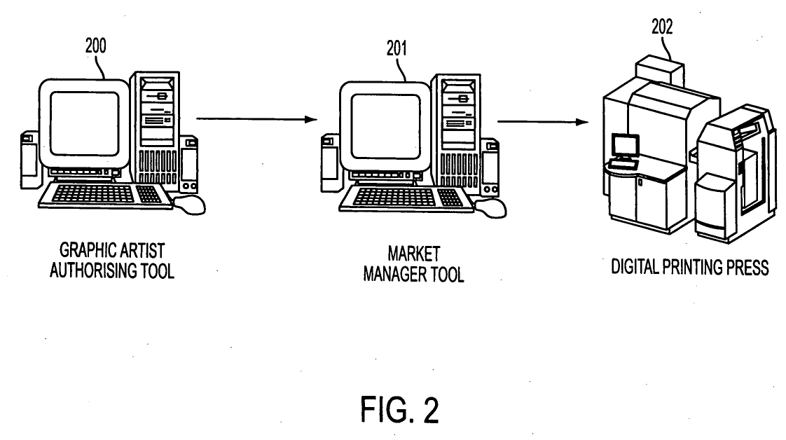

The post rendering rules may be situated in a marketing manager tool as described with reference to FIG. 2 herein.

An example of a post rendering rule may be as follows:

“Perform rendering on variable (dynamic) content.”

“If, after the rendering, there is available space in the vertical page direction having dimensions between X₀ and X₁, then insert static content item A.”

The static content item A, can be selected such that it fits within a height in the range X₀ to X₁ on a page.

Another example of a rule may be:

“If the remaining space unfilled by content is less than X₀, then leave as a void.”

The above basic post-rendering rules can be combined with requirements which are specific to a print customer. For example, where the documents are bank statements are credit card statements, the print customer (a bank, or a credit card services company) may wish to analyse the spending patterns for each account holder, and target their content to a service aimed at a particular spending pattern. For example, where a credit card statement shows a significant expenditure on clothing, the bank or credit card service provider may wish to include content in a void space on the statement for a particular customer, where the content relates to a promotional offer for a particular clothing retailer,

The void spaces in a document, can be used for content which is aimed at a particular customer or type of customer, where the type of content is specified by a set of post-rendering rules.

A further example of a post-rendering rule, which is customer specific to a particular print customer may be as follows:

“If account shows spending of more than £500.00, insert content item B.”

Content type B may comprise an object specifying that a customer has been awarded bonus points. For example:

“Your current level of spending entitles you to 500 free bonus points, in addition to your normal bonus points. Bonus points can be spent on any of the wide range of goods and services in our bonus catalogue.”

Another example may be to provide a detachable voucher, for a fixed amount, to be used at a particular retail outlet. In that example the quality of printing must be very high, to avoid forgery of the vouchers, so this type of content is well suited to a digital printing press.

Each document in a print run may contain:
a base content, comprising one or more static content items, and one or more variable content items which differ from document to document; and
optionally, and depending upon a set of post-rendering rules, a further additional content, which may comprise a static content item and/or one or more variable content items, where those content items are specified by a set of post-rendering rules.

The post-rendering rules may operate to select or specify pre-determined types of content items depending upon a type of information specified in the base content items. The post-rendering rules may, alternatively specify absence of content, i.e. no content is to be inserted.

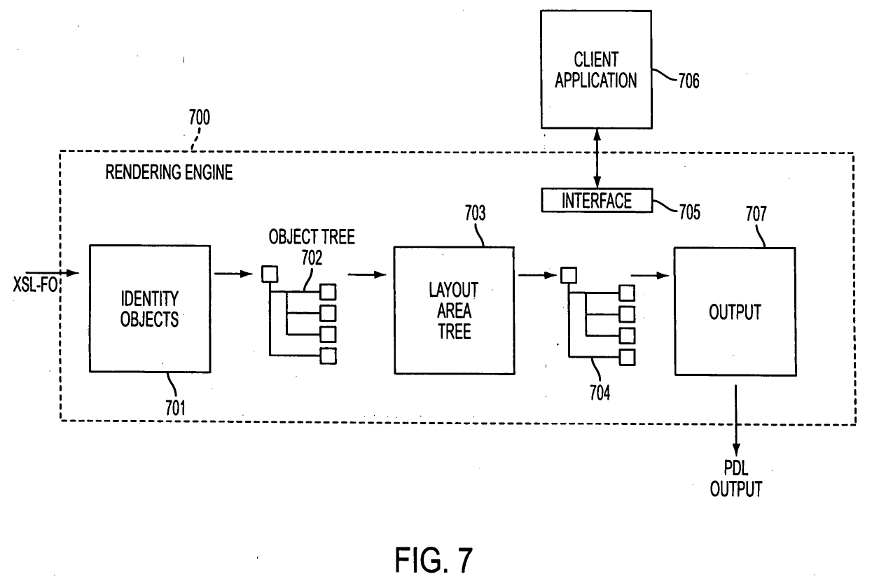

Referring to FIG. 7 herein, there is illustrated schematically processes carried out within a modified rendering engine according to a specific embodiment of the present invention.

The rendering engine may be modified by means of API's which allow an external application to look inside the rendering engine, and apply modifications within a rendering process carried out by the rendering engine. Within a modified rendering engine 700, there is provided a component 701 for identifying objects in an XSL-FO flow; an object tree structure 702 for arranging the objects within a copy flow, in an arrangement whereby they can be easily identified and their location within an internal cache in the rendering engine is recorded; a layout area tree component 703 for arranging areas in documents into a tree structure 704 in which they can be easily referenced and identified; an interface 705 accessible by a client application 706, whereby the client application can insert content items into particular areas of documents in a content flow, according to a set of post-rendering rules; and an output component 707 which outputs a page description language output. The area layout tree 704 enables, for each page, a position of each object comprising an X, Y co-ordinate position, to be recorded as well as allowing a whole sequence of a plurality of pages to be set out.

The interface 705 enables an insight into the rendering engine to be made by client application 706, and for the client application to determine how the objects are laid out within a copy flow, and thereby to determine how much space will be left at the end of each page of a copy flow, and in each document in the copy flow.

The interface can be used for writing information to the layout area tree, as well as for reading information from the layout area tree. By changing the information in the layout area tree via the interface, client application 706 can add or delete content items from the copy flow, or change the position of content items within pages in the copy flow. Construction of the interface may be effected in a known programming language, as will be known to those skilled in the art.

The interface can also be used to provide information for identifying errors in layout of the copy flow, which can be checked by the client application, and if necessary, amendments to the layout can be made by the client application.

A graphic artist using a graphic artist authoring tool, generates a DTF flow, which is based upon XSL-FO. This enables a variable number of pages to be generated. A set of pre-rendering rules related to the rendering of the flow may be resident in a marketing manager tool. Further, a set of post-rendering rules can be applied, which allows incorporation of additional content to the document, depending on an amount of space which the base content will occupy in the rendered documents.

The rule engines can run either in a print shop, or in a computer entity in an enterprise outside the print shop, for example in a marketing manager tool.

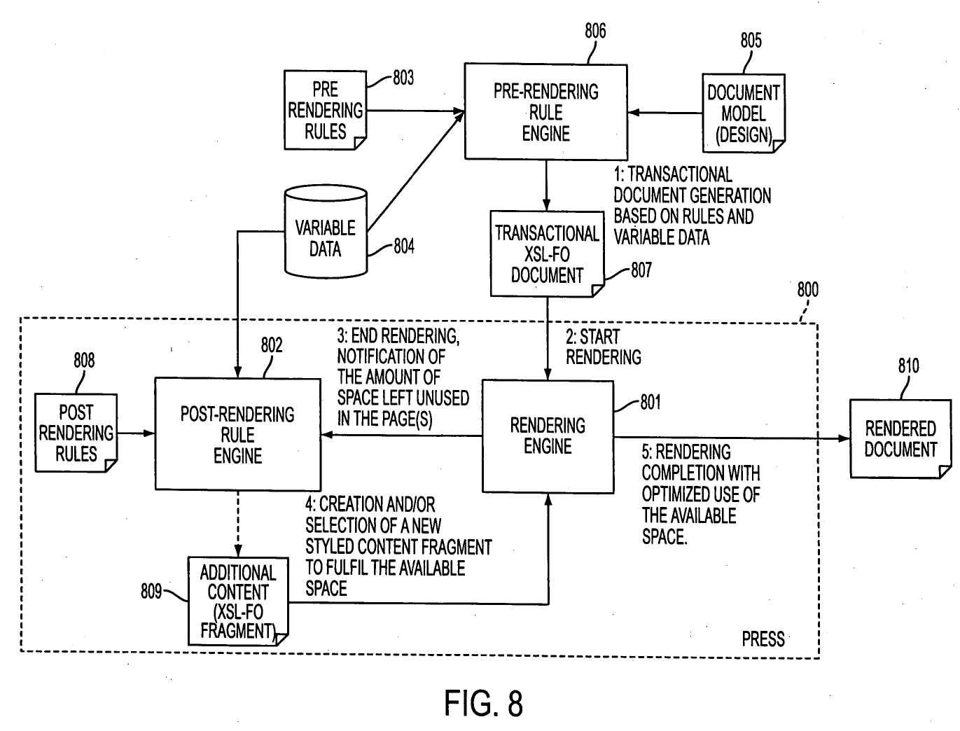

Referring to FIG. 8 herein, there is illustrated schematically a first digital printing system incorporating a rendering engine according to the first specific embodiment of the present invention.

The digital printing system comprises features of a known digital press as will be understood by the persons skilled in art, and additionally, modifications as shown schematically in FIG. 8. The digital printing press 800 comprises a rendering engine 801; and a post-rendering rule engine 802.

The digital press of operates as follows. The rendering engine has been extended to interact with the post-rendering rule engine, which can create styled fragments on the fly which suit an available space. Post-rendering rules are written beforehand and produce the content using information such as the amount of space available, as well as the information related to the customer and/or products or services.

Optimization is carried out on the press side, and enables flexibility in optimization of utilization of space in a document, but requires the knowledge of customer information.

A set of pre-rendering rules 803 and a set of variable data 804 and a document model 805 are input into a pre-rendering rule engine 806. A document (in the example shown a transactional document) is generated based upon the rules applied by the pre rendering rule engine, and the variable data according to the document model which sets out the design of each document within a flow of documents. This results in an output document 807 (in this example a transactional document), which is received by rendering engine 801. The document 807 is in a document description language (DDL) for example, XSL-FO. The rendering engine 801 commences rendering of the document 807 output from the pre-rendering rule engine, and generates data describing an amount of unused void space in the document, specifying which page that space occurs on, as well as a spatial extent of the space. That information is received by post-rendering rule engine 802, which also receives additional variable data 804, and applies the additional variable data 801 to generate an additional content 809 (in the form of an XSL-FO fragment in the example shown), as a result of applying a set of post-rendering rules 808, according to the information received from the rendering engine 801 upon the amount of space left unused in the document pages. The post-rendering rule engine creates or selects a new content fragment to fill the available void representing unused space in the DDL document 807. The additional content 809 is input into the rendering engine 801, and incorporated into the DDL document to produce a complete rendered output document 810 which has the available space in the document optimally used.

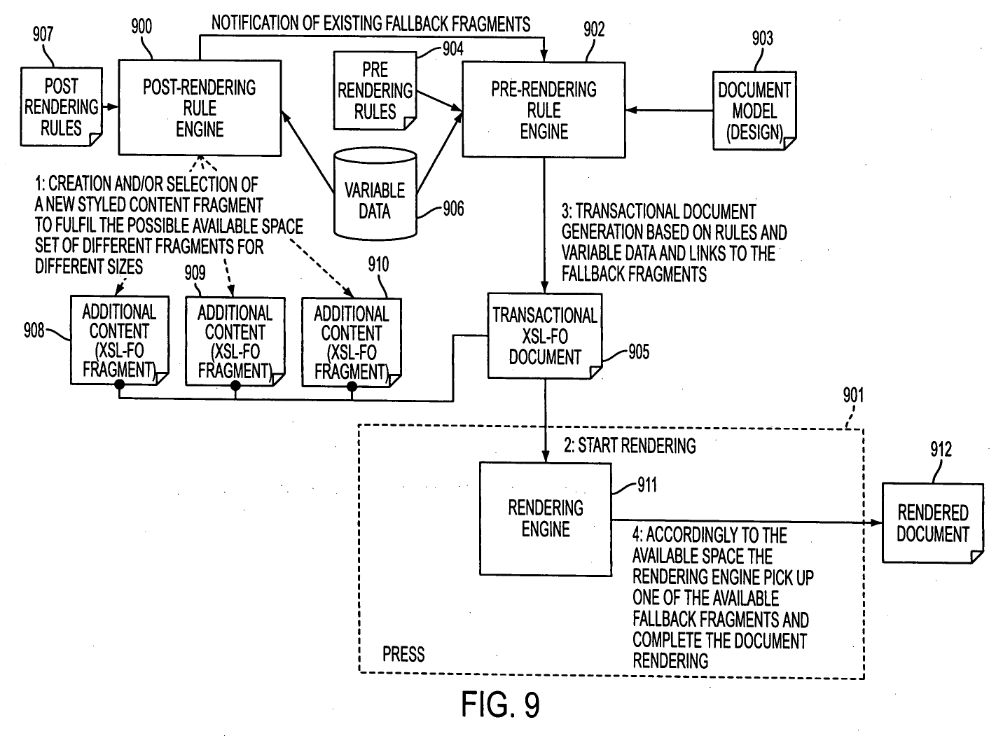

Referring to FIG. 9 herein, there is illustrated schematically a second digital printing system according to a second specific embodiment of the present invention, which includes a modified digital printing press, and shows operation of a modified rendering engine in a case where the base content specified in a document does not quite fill the document and leaves a void space.

The second digital printing system comprises: a digital printing press 901 having a rendering engine 911; a post-rendering rule engine 900; a pre rendering rule engine 904; and a database 906 containing static content items and variable content items.

In the example FIG. 9, the post-rendering rule engine 900 is situated outside the digital printing press 901 in a separate computer entity, for example in a marketing manager tool computer entity. Pre-rendering rule engine 902 receives a document template 903, which is designed by a graphic artist, using a conventional graphic artist authoring tool; and applies a set of pre-rendering rules 904 to the document template which specifies variable content items to be included into a content flow specified by the document model, to produce a flow of documents 905 output from the pre-rendering rule engine in a document description language. The variable content items are stored in variable content database 906, and may be supplied by a customer for the print services, for example a bank or other institution. Examples of variable content data may include financial account data.

Post-rendering rule engine 900 notifies the pre-rendering rule engine 902 of a set of additional content items (also called herein fall-back fragments), which are to be used in the event that after rendering there are pages within each document with void spaces. The pre-rendering rule engine 902 incorporates in the output copy flow which it produces, links to the additional content items specified by the post-rendering rule engine according to a set of post-rendering rules 907.

Post-rendering rule engine 900 applies a set of post-rendering rules 907 to create and/or select a set of additional content items which may be used to fulfill available space under circumstances where documents are produced where the base content is of a size such as to produce void spaces within each document. The post-rendering rules may specify a range of individual additional content items 908-910, each having different sizes and occupying different areas within a document layout.

Rendering engine 911 commences rendering the DDL document received from the pre-rendering rule engine 902, at which point, any void spaces in the rendered documents become apparent.

According to the available void space in each document, the rendering engine selects one of the additional content items specified in the DDL document, in order to complete the rendering of each document, filling in any void spaces with an additional content item selected to be of a correct size for the particular void space in each document. Where a document has variable base content which results in no void spaces, or void spaces below a pre-determined size within the rendered document, no additional content item is included in the final rendered document by the rendering engine. However, in cases where the DDL document output from the pre-rendering rule engine, after rendering of the base content results in a void space, an appropriately sized pre-specified additional content item will be included by the rendering engine and rendered in the final rendered document, thereby producing a final rendered document, which includes one or more additional content items. The additional content items, are preferably static content items, that is content items which do not have a variable size. However in other specific methods, the additional content items may be of variable size, in which case an additional content item having a size which fits within a void space in a document is selected.

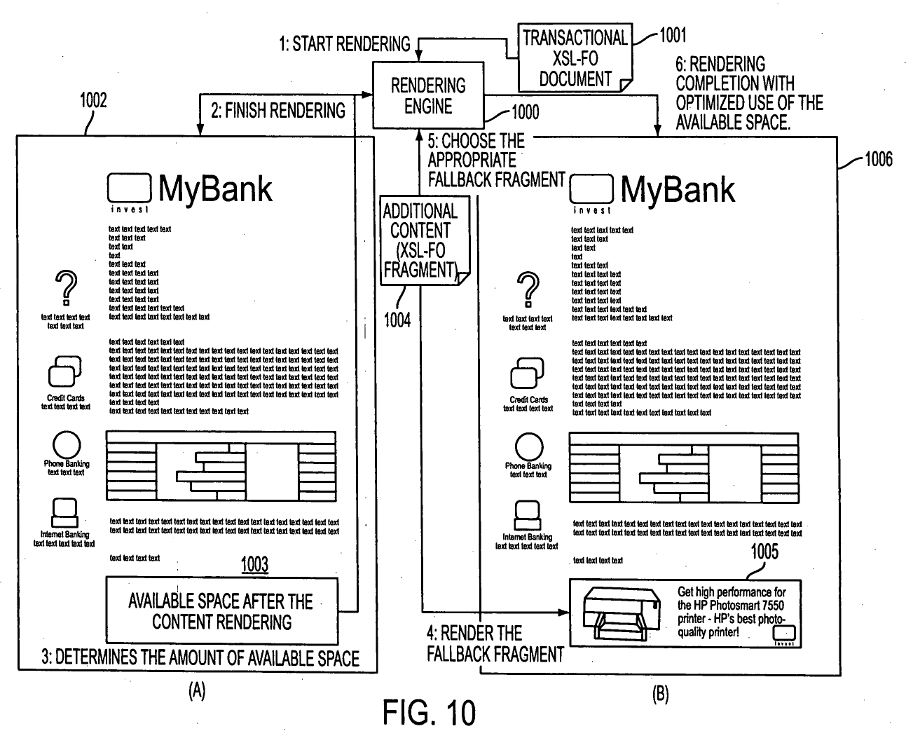

Referring to FIG. 10 herein, there is illustrated schematically processes carried out by a rendering engine as described herein according to any one of the above described embodiments, for inclusion of additional content, where a void space in a document after rendering of the base content, is relatively small.

The rendering engine 1000 commences rendering of a document 1001 specified in a document description language. The DDL document 1001 contains a base content, which when rendered results in a rendered electronic file illustrated graphically by the rendered document 1002 in FIG. 10. After the first stage rendering in which the base content is rendered, there remains an available void space 1003 at the end of the rendered document. The rendering engine determines the amount of available space in the rendered document 1002. This information may be made available to a post-rendering rule engine, which supplies an additional content item 1004 to the rendering engine. The rendering engine renders the additional content item to produce a rendered additional content item 1005. The additional content item can be either specified in the DDL document 1001 received by the rendering engine, where the system of FIG. 9 is used, or, where the system of FIG. 8 is used, the additional content item can be selected by the post-rendering rule engine which comprises part of the digital printing press. Rendering engine 1000 selects an appropriate additional content item from a plurality of additional content items which may be specified in the received document 1001 and proceeds to render a complete document file including both the base content and the additional content item, where an additional content item which optimizes the use of the void space in the document left after rendering of the base content is included.

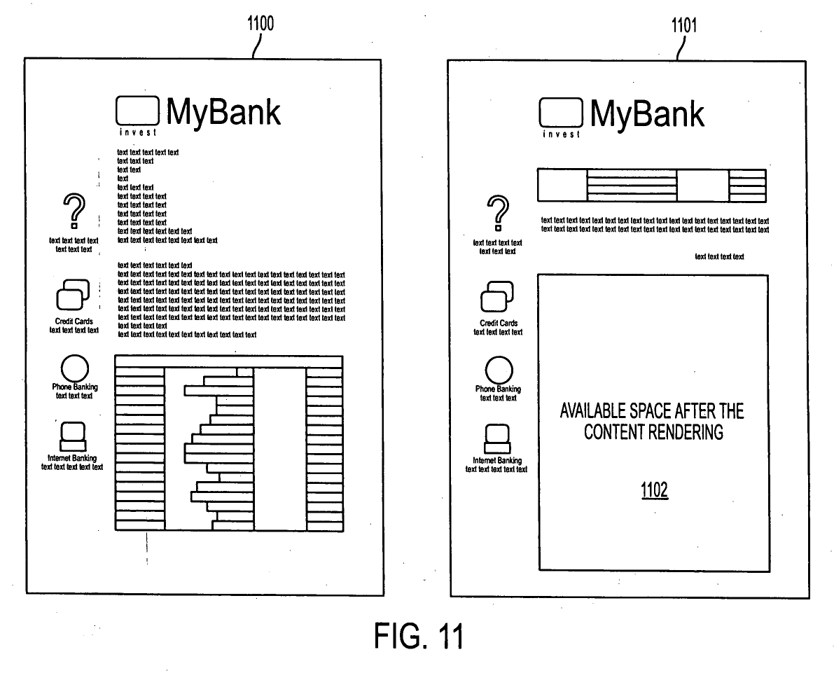

Referring to FIG. 11 herein, there is illustrated schematically a document comprising first and second pages 1100, 1101 respectively at a stage after a first rendering operation, in which a base content comprising a plurality of static content items, and a variable content item has been rendered. The combined static base content and variable base content occupy enough space in the document to take the document into two pages, but leaves a void space 1102 at the end of the second page.

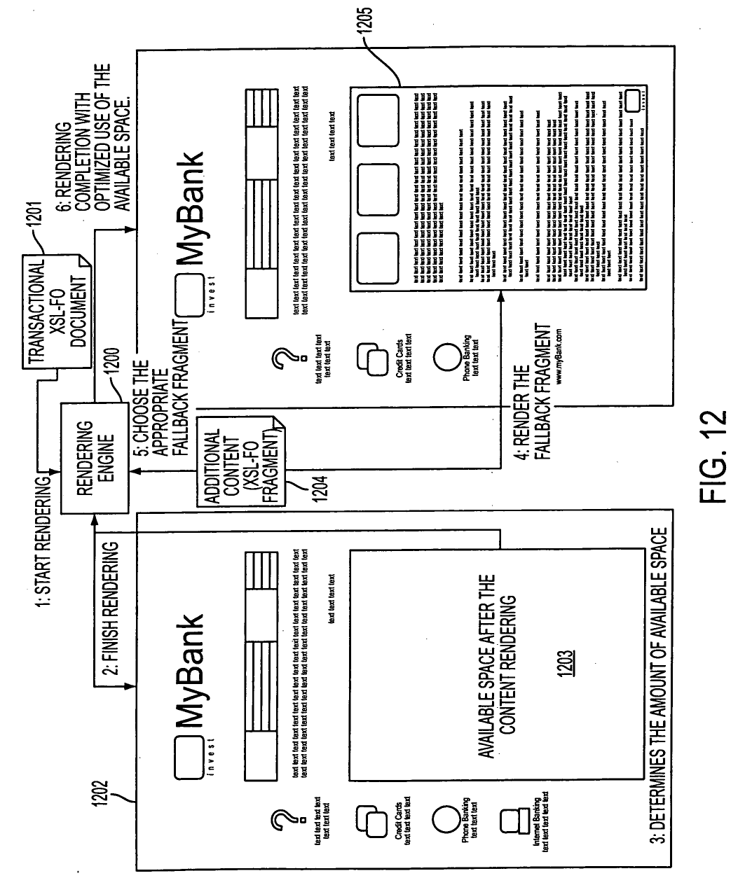

Referring to FIG. 12 herein, there is illustrated schematically processes carried out by rendering engine 1200 for incorporating an additional content item into a second page of the document shown in FIG. 11 herein. The rendering engine 1200 receives a DDL document 1201 comprising static base content and/or variable base content, and a document template comprising one or more static copy holes and/or one or more variable copy holes, in which to incorporate the static content and/or the variable content. This results in a rendered document of which the second page 1202 includes a void space 1203. The rendering engine determines the amount of available space in the second page 1202 of the document and renders an additional content fragment 1204 to produce a rendered additional content fragment 1205. Where more than one additional content item is available as is usually the case, the rendering engine may select an appropriately sized additional rendered content item to fit into the available space in the second page of the document. The rendering engine proceeds to produce a complete rendered document having both the base content and the additional content, such that the void space in the second page of the document is optimized, by inclusion of the additional content item. It would be appreciated by those skilled in the art that where the document extends to more than two pages, void spaces may occur on the last page of the rendered document and the additional content item may be incorporated on that last page.

However, void spaces are not necessarily restricted to occur on the last page of the document, but in the general case, may appear anywhere in the document, on any page of a multi page document, and one or more appropriately sized additional content items may be selected from a range of pre-determined additional content items, to fit into any void spaces which result due to variations in the space occupied by variable base content specified within a document.

The specific embodiments and methods described herein describe a rendering engine which is modified so as to be able to expose a final layout of a rendered document, thereby identifying any void spaces which may occur in a final rendering of a base document. The base document can be modified by incorporation of additional content items prior to final rendering, by application of a set of post-rendering rules.

The post-rendering rules may apply variable content or static content, and the additional content maybe selected or generated to be specific to an information contained in the base content of the base document. The rendering engine is capable of exposing both a page location, a location within a page, and an area and/or size of any void which will occur in the rendered based document, before the document is finally rendered into an output document, and enabling those voids to be filled with additional content before the final document comprising the base content and the additional content is rendered to produce an output rendered flow.

Specific embodiments disclosed herein introduce a concept of post processing, rule based, style fragment generation which obtains from a rendering engine information regarding an amount of space left in a document, and completes the rendering with an appropriate fragment to complete the document rendering.

1. A method of generating a document comprising:
receiving a document template and a set of base content items for inclusion in said document;
rendering the set of said base content items;
determining an extent of any void spaces in said document after rendering of said base content items; and
depending upon the extent of said void spaces, inserting a further additional content item into said document.

2. The method as claimed in claim 1, wherein said additional content is selected from a set of pre-determined content items, according to a set of rules which select said additional content according to an information content of said base content items.

3. The method as claimed in claim 1, wherein said set of base content items comprise at least one static content item.

4. The method as claimed in claim 1, wherein said set of base content items comprise at least one variable content item.

5. The method as claimed in claim 1, wherein said document template comprises at least one static copy hole for inclusion of a static content item.

6. The method as claimed in claim 1, wherein said document template comprises at least one variable copy hole, for inclusion of at least one variable content item.

7. An apparatus for generating a rendered document from a set of base content items, comprising:
a rendering engine operable for rendering said document;
a component operable for identifying void spaces in said document;
a component capable of supplying at least one additional content item and capable of incorporating said at least one additional content item into said document; wherein
said rendering engine is operable for rendering said document, inclusive of said at least one additional content item.

8. The apparatus as claimed in claim 7, wherein said component for identifying void spaces comprises:
means for objectifying said set of base content items;
means for identifying a position of said base content items within a layout of said document; and
means for locating a position and size of said void space in said document.

9. The apparatus as claimed in claim 7, wherein said component for identifying void spaces is situated at least partially, externally of said rendering engine.

10. The apparatus as claimed in claim 7, wherein said component capable of supplying at least one additional content item comprises:
a post-rendering engine adapted for selecting said at least one additional content item according to a set of post-rendering rules.

11. The method as claimed in claim 7, wherein said set of base content items comprise at least one variable content item.

12. The method as claimed in claim 7, wherein said at least one additional content item is incorporated into said base document at a position corresponding to a said identified at least one void area.

13. A method of generating a print run, said method comprising:
generating a base document in a document description language by applying a set of pre-rendering rules to a set of variable data;
identifying a void area in said base document;
generating information describing a location of the void area;
applying a set of rules which assign content to the void area;
obtaining at least one additional content item and generating a rendered document incorporating the additional content item into the void area of the base document.

14. The method as claimed in claim 13, wherein said document description language comprises extensible style sheet language formatting objects (XSL-FO).

15. A digital press comprising:
a rendering engine capable of identifying at least one void space within a document received by said rendering engine;
means for generating information describing a location of said void space;
means for applying a set of rules which assign additional content items to said void area; and
means for rendering said base document by incorporating said additional content items in the void area, to produce an output rendered document.

16. A rendering engine comprising:
means for identifying content items in a copy flow, and converting said copy items to objects;
storage means for storing said plurality of objects;
means for arranging said objects into an object structure in which a location of each object in said storage means is recorded;
means for determining a page layout of said plurality of objects in a plurality of pages of said copy flow; and
an interface means for allowing an external application to view said page layout, and to modify said page layout.

17. The digital printing press as claimed in claim 16, wherein said means for generating information describing a location of at least one void space comprises a memory device capable of storing a layout tree describing a layout of at least one page within said document.

18. The digital press as claimed in claim 16, wherein said means for applying a set of rules comprises:
a rule engine component which is operable to apply a set of post-rendering rules to said document.

19. The digital press as claimed in claim 16, wherein said document is received in a document description language.

20. The digital press as claimed in claim 16, wherein said document is received in extensible style sheet language formatting object (XSL-FO).

21. A digital printing system comprising:
a pre-rendering rule engine capable of applying a set of pre-rendering rules to a document template, said pre-rendering rules being operable for incorporating a set of base content data into said document template to produce a document in a document description language;
a rendering engine for rendering said document;
a post-rendering rule engine operable for applying a set of additional content items to said document template, according to a set of post-rendering rules; and
a rendering engine for rendering at least one document according to said document template, inclusive of said base content items and said additional content items added as a result of said post-rendering rules, to produce a rendered document.

22. The printing system as claimed in claim 21, wherein said rendering engine and said post-rendering rule engine are located within a digital printing press.

23. The printing system as claimed in claim 21, wherein said rendering engine and said post-rendering rule engine are located within a digital printing press; and
said pre-rendering rule engine is located within a separate computer entity, capable of interfacing with said digital printing press via an interface provided to said rendering engine.

24. The printing system as claimed in claim 21, wherein said base content data comprises at least one variable content item.

25. A computer program product for creating a document from a plurality of content items, the program being adapted to:
render, in accordance with a predetermined set of rules, the content objects into a document layout suitable for rasterising into a bitmap;
analyse the post-rendered document layout to establish whether it contains a void space; and
to insert an additional content item into the void space in accordance with a post rendering rule.

26. A program product according to claim 25 wherein the post-rendering rule selects an additional content item from a plurality of predetermined additional content items.

27. A program product according to claim 25 wherein the post-rendering rule selects an additional content item in dependence upon the size of the void space and the size of the additional content item.

28. A program product according to claim 27 wherein the post-rendering rule selects an additional content item additionally in dependence upon the nature of the content of the document.

29. A program product according to claim 25 wherein the content items and the additional content items are selected from the group consisting of static content items and variable content items.
